(19) United States
(12) Patent Application Publication
(10) Pub. No.: US 2003/0007257 A1
(43) Pub. Date: Jan. 9, 2003

(54) Facial contact lens system for laser diode

(76) Inventors: Bernard W. Bell JR., Lafayette, CO (US); Ian R. Redmond, Boulder, CO (US); Masud Mansuripur, Tuscon, AZ (US)

Correspondence Address: SHERIDAN ROSS PC, 1560 BROADWAY, SUITE 1200, DENVER, CO, 80202

(21) Appl. No.: 09/900,722

(22) Filed: Jul. 6, 2001

(51) Int. Cl. G02B 13/18; G02B 27/10; G02B 3/02

(52) U.S. Cl. 359/719; 359/618

(57) ABSTRACT

A beam shaper lens or other optic is positioned with respect to a laser diode or other laser emitter in such a way as to eliminate an air gap, or other low-index region, between the emitter and the beam shaper optic. In one embodiment, a planar emitter is in direct face-to-face contact with a planar surface of a beam shaper lens. The beam, as it exits the laser source, directly enters the lens or another relatively high-index medium, compared to the index of air. By reducing the number of interfaces which the beam passes through and/or the difference in index across such interfaces, beam shaping can be achieved while reducing or eliminating interfacial reflections, refractions, or diffractions.

### CROSS-REFERENCE TO RELATED APPLICATIONS

Cross-reference is made to U.S. patent application Ser. No. 09/315,398 entitled “Removable Optical Storage Device and System” filed May 20, 1999, U.S. Patent Application No. 60/140,633 entitled “Combination Mastered and Writeable Medium and Use in Electronic Book Internet Appliance” filed Jun. 23, 1999, U.S. patent application Ser. No. 09/457,104 filed Dec. 7, 1999 entitled “Low Profile Optical Head” and U.S. patent application Ser. No. 09/764,026 filed Jan. 16, 2001 (Attorney File No. 4154-19) entitled “Beam Shaper for Optical Read/Write Device”, all of which are incorporated herein by reference.

The present invention is related to a method, system and apparatus which provides a lens or other optic component in connection with a light source and in particular to a method system and apparatus in which the optic has a planar face which is coupled in face-to-face contact with a planar face, such as the cleaved facet, of a laser diode in and which the optic changes optical characteristics of the light which is output by the light source such as reducing or otherwise changing its divergence, reducing astigmatism or circularizing the light beam or other changes.

### BACKGROUND INFORMATION

Laser diodes and other strong or concentrated light sources have found use in a number of devices and processes including, for example, data recording, reading, or read/write devices including CD (compact disc) players and recorders, DVD (digital versatile disk) players and recorders, and devices such as those described in U.S. patent application Ser. Nos. 09/315,389,60/140,637 and 09/457,104, supra, bar code scanners and other light beams scan devices, and the like. The light which is output from various light sources will generally have characteristics which may be advantageous for certain purposes or in certain contexts and may have other characteristics which can be undesirable in certain devices or contexts. For example, the light which is output from a typical edge-emitting laser diode will be output in a divergent beam. While diverging beams may not be undesirable for all purposes or in all contexts, it is believed that, in at least the context of optical data devices such as that described in U.S. patent application Ser. Nos. 09/315,389, 60/140,637 and 09/457,104, supra, it can be useful to eliminate, or at least limit or reduce, the amount of divergence (such as by reducing or limiting the divergence angle or angles). By providing a reduction of divergence angles, a given size or diameter of a downstream optic (such as an objective lens or other optic) will “capture” a larger portion of the total energy from the beam (reducing or avoiding “overfilling” a lens or other optic) leading to increased efficiency (such as by avoiding or reducing the loss or “spilling” of light energy). More efficient designs can contribute to an improved energy budget for an apparatus (e.g., providing lower power consumption, longer battery life and the like) and improvements in the heat budget of a apparatus (reduction in the amount of energy ultimately wasted as heat). Furthermore, light beams with reduced divergence can, in general, be used in connection with smaller-diameter lenses or other optics which are, in general, more tolerant of lens defects or errors and accordingly easier and/or less expensive to manufacture.

Another characteristic of side emitting laser diodes that can be undesirable in at least some devices or contexts, is the characteristics wherein the magnitude or angle of divergence of the beam measured in a first plane (passing through the beam's longitudinal or “z” axis) is different from the magnitude or angle of divergence measured in a second, different plane (also passing through the z axis), such as a second plane perpendicular to the first plane. As a result of such differing divergence angles, the cross-sectional shape of the beam (the shape of the beam's intersection with a plane perpendicular to the z axis) will be non-circular (generally referred to, hereafter, as elliptical). Elliptical beams can be disadvantageous because there will typically be an amount of inefficiency when an elliptical beam reaches a (usually circular-shaped) lens or other optic and, in devices such as optical read/write devices of the type described in U.S. patent application Ser. Nos. 09/315,389, 60/140,637 and 09/457,104, supra, an elliptical beam will result in a non-circular “spot” at the location of the disk or other medium.

Various approaches have been tried in attempts to deal with these and other disadvantageous aspects of a beam's divergence or shape. One approach is to adopt a light source which avoids or reduces divergence or non-circularity. For example, a vertical cavity, surface-emitting laser (VCSEL) (e.g., as described in U.S. patent application Ser. No. 09/315,398 filed May 20, 1999, incorporated herein by reference) can provide substantial circularity of the beam and/or reduce or eliminate astigmatism in the beam. However, compared to laser diodes, VCSEL's are, at present, generally more expensive, more difficult to fabricate, have more limited output powers and and are in limited supply.

Another approach has been to position a generally conventional lens or similar optic along the optical path, somewhere downstream of, and spaced from, the laser diode. In this approach, the laser beam, as it is emitted from the emitting-facet of the diode, travels through the air a distance and then reaches the beam-shaping (e.g., divergence-reducing and/or circularizing) lens. After passing through the beam-shaping lens, the (shaped) beam will then be provided to other components of the apparatus, e.g., other lenses, recording media, mirrors, detectors, and the like). As can be seen, this approach means that the beam will have, or experience, a first interface when it passes from the laser diode medium, typically a high-index-of-refraction(“high index”) medium, into air (which has an index of a refraction of about 1.0), a second interface when it passes from air into the beam-shaping lens and a third interface when it exits the beam-shaping lens, typically into air. Thus, previous approaches for beam-shaping had typically added to the number of interfaces the beam experiences moreover, have typically provided interfaces which separate relatively large differences in index of refraction (such as the difference between air and the, typically substantially higher index-of-refraction for a beam shaping lens). An increase in the number of interfaces, particularly interfaces with large differences in index of refraction, can be undesirable since each interface can contribute loss of efficiency (such as by creating internal reflections, unwanted diffraction or refraction and the like) and other undesirable optical consequences, especially when the interface separates a relatively large difference in indices of refraction.

Accordingly, it would be useful to provide an approach for limiting or decreasing beam divergence, increasing circularization (decreasing ellipticity) or otherwise shaping a beam, while reducing the number of interfaces and/or the difference between indices of refraction at such interfaces, compared with previous approaches including as described above.

Another difficulty associated with previous approaches has been the difficulty of and/or expense associated with positioning and/or mounting the beam shaping lens in the desired position with respect to the laser diode. In general, a beam shaping lens should be positioned at a desired distance, along the beam propagation axis or “z” axis, away from the laser-emitting facet, and at a desired lateral position and/or angle with respect to the z axis (typically with the optical axis of the lens co-linear with the z axis). Providing the requisite accuracy of positioning and mounting a beam shaping lens can be particularly difficult or expensive in the context of miniaturized components or apparatus, including as described in U.S. patent application Ser. Nos. 09/315,389, 60/140,637 and 09/457,104, supra. Accordingly, previous approaches which may have been acceptable for some purposes may be infeasibly difficult or expensive to implement in the context of other devices such as miniaturized devices, e.g., U.S. patent application Ser. Nos. 09/315,389, 60/140,637 and 09/457,104, supra. In some previous approaches, beam shaping lenses were provided with one or more reference edges for contacting points or lines on the laser diode surface to assist in positioning the beam-shaping lens in a desired spaced-apart position with respect to the laser diode. Such approaches provided line contact or point contact but did not provide face-to-face or planar contact with the emitting face or plane of the laser diode. For example, it is believed that when two or more components are joined along lines or at points, the connection may be less sturdy or durable than configurations in which components are joined along the planes or “face-to-face.” Sturdiness and durability of such connections can be particularly important in the context of personal electronic devices (PEDs) which may be routinely subjected to high accelerations or jostling (such as being mounted in a truck or automobile, worn by a user while jogging and the like). Moreover, such approaches, since they define an air gap between the laser and the lens, involved an increase in the number of high-index-difference interfaces, as described above.

Accordingly, it would be useful to provide a system, method and apparatus for beam shaping which reduces the difficulty and/or expense of positioning a beam-shaping optic with respect to a laser diode particularly in the context of small or miniaturized devices such as those described in U.S. patent application Ser. Nos. 09/315,389, 60/140,637 and 09/457,104, supra.

Another potential disadvantageous aspect associated with laser diodes is that the light-emitting facet of the diode may lie in a plane which is not precisely perpendicular to the wave guide axis of the laser diode. When this happens, the z axis or propagation direction of the beam as it exits the laser diode may be other than co-linear with the wave guide axis and/or the beam may be undesirably asymmetric with respect to the beam z axis. Accordingly, it would be useful to provide a system, method and apparatus which can reduce the magnitude of at least some of the undesired effects which arise from a laser diode emission facet which is not perpendicular to the wave guide axis.

### SUMMARY OF THE INVENTION

The present invention includes a recognition of the existence, source and/or nature of problems in previous approaches, including as described herein.

According to one aspect, a beam-shaping optic such as a beam-shaping lens includes a substantially planar surface and the beam-shaping optic is mounted such that the planar surface of the beam-shaper optic is adjacent, and parallel to, and preferably in planar face-to-face contact with, the laser-emitting facet of a laser diode. One aspect of the invention involves eliminating the need for the laser beam to travel through air (or a similar low index medium) after it leaves the laser diode and before it reaches the beam-shaping optic. In this way, the present invention can make it possible to reduce the number of interfaces and/or the magnitude of the change in indices of refraction, at interfaces which the beam experiences or passes through between the time it exits the laser diode and the time it exits the beam-shaper optics. An adjacent, preferably planar-contact, positioning of the beam-shaper optic, with respect to the laser diode facet, is believed to provide a configuration which can be relatively readily fabricated, at modest cost, compared to at least some previous approaches and to provide a mounting which is secure and durable especially in the context of small or miniaturized optical devices. U.S. patent application Ser. Nos. 09/315,389, 60/140,637 and 09/457,104, supra. By providing a configuration in which the laser beam, upon exiting the laser diode facet, passes through a material with an index of refraction substantially higher than that of air, it is believed that at least some undesirable effects of any non-perpendicularity of the emitting-facet (with respect to the wave guide axis) can be reduced or eliminated, including, for example, the degree or amount of the resultant beam deviation produced.

### BRIEF DESCRIPTION OF THE DRAWINGS

FIG. 1 is a generalized perspective view of a laser diode and mount illustrative of one type of laser diode that can be used in connection with embodiments of the present invention;

FIGS. 2A and 3B are top and side views of a laser diode and a beam emitted therefrom according to some previous approaches;

FIGS. 3A and 3B are top and side views of a laser diode and lens system according to an embodiment of the present invention;

FIGS. 4A and 4B are top and side views of a laser diode and lens system according to an embodiment of the present invention;

FIG. 5 is a side view of a laser diode and lens system, and a beam emitted therefrom according to an embodiment of the present invention;

FIG. 6 is a side view of a laser diode and lens system according to a previous approach;

FIG. 7 is a side view of a laser diode and lens system according to a previous approach;

FIG. 8 is a perspective, partially exploded, view of a laser diode and lens system according to an embodiment of the present invention;

FIG. 9 is a partially-exploded side view of a laser diode and lens system according to an embodiment of the present invention;

FIG. 10 is a cross-sectional view of a laser diode and lens system according to an embodiment of the present invention;

FIG. 11 is a side view of a laser diode with a non-perpendicular facet showing a center line of the beam emitted therefrom, according to previous approaches; and

FIG. 11B is a side view of a laser diode and lens system, with the laser diode facet being non-perpendicular, according to an embodiment of the present invention.

### DETAILED DESCRIPTION OF THE PREFERRED EMBODIMENTS

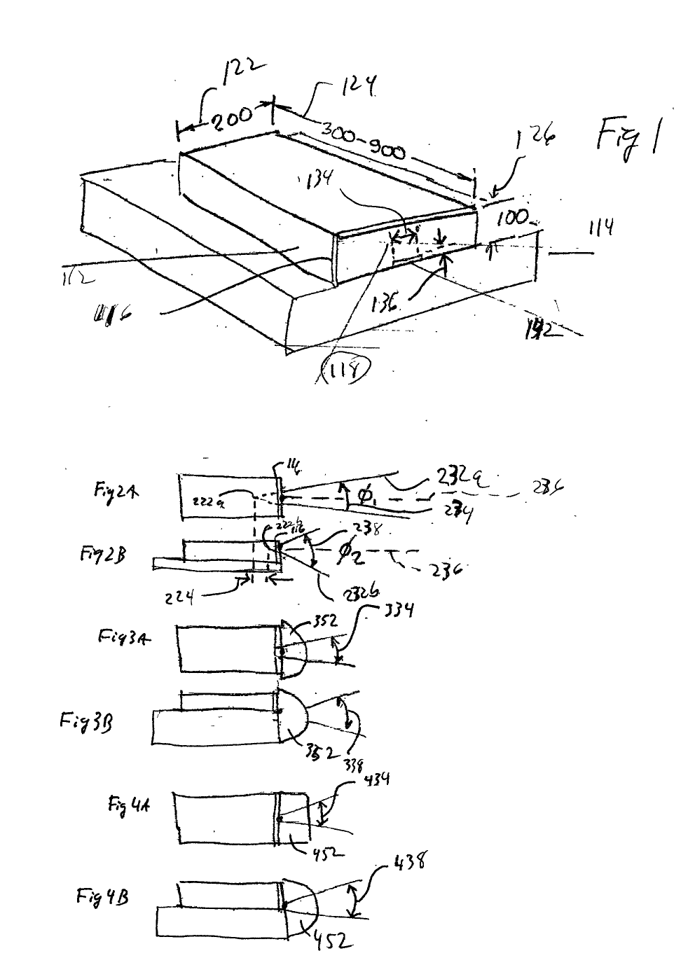

Before describing aspects of the present invention, certain features of laser diodes and of previous approaches will be described. As shown in FIG. 1, the laser diode 112 is typically mounted on a mount and/or heat sink structure 114 which can be formed of a material such as silicon carbide (SiC). The laser diode 112 includes an emitting facet 116 which is typically formed by cleaving a larger structure and is typically coated with a dielectric coating 118, typically comprised of a plurality of dielectric layers (“stacked plate”) with the composition and thickness of the layers or plates being selected and configured to provide a desired amount of reflection of light back into the laser cavity, in a manner understood by those of skill the laser diode art. Typically, the dielectric coating will have a thickness of less than one micrometer.

The present invention could be used in connection with a number of types of laser diodes including, by way of examples, a 650 nanometer wavelength laser diode such as an aluminum gallium indium phosphide, multi-quantum well diode such as Model GH06507A2A available from Sharp and/or a 401 nanometer wavelength (violet) gallium nitride laser diode such as Model NLHV500A available from Nichia Corporation, blue light lasers and the like. A number of sizes of laser diodes and mounts can be used in connection with the present invention. In one embodiment, the laser diode has a width of about 200 micrometers, a depth of about 300 to 900 micrometers and a height of about 100 micrometers.

An emitter region 132 on the laser diode facet 116 defines the region from which laser light is emitted. The size and shape of the emitter region 132 will vary for different types or models of laser diodes. As one example, in a typical 680 nanometer laser diode, the emitter region has a width 134 of about 3 micrometers and a height 136 of about 1 micrometer.

As seen in FIGS. 2A and 2B, a light beam 212a, 212b emitted from a typical laser diode is a diverging light beam. Typically, the beam will have a non-circular (elliptical) cross-sectional shape, and the angle of divergence 214 in a first plane (e.g., a horizontal plane) passing through the beam propagation axis 216 will be different from the divergence angle 218 in a second (e.g., vertical) plane also passing through the propagation or “z” axis 216. As one example, typical values for a 650 nanometer laser diode would be a horizontal divergence angle 214 of about 9° and a FWHM (full width half maximum) vertical divergence angle 218 of about 29° (to provide a divergence angle ratio of about 3.4). By tracing the edges of the beams 212a, 212b backwards (towards the laser diode), it is possible to define an apparent or virtual point of origin of the beam 222a, 222b for each plane which passes through the axis of propagation 216.

FIG. 6 illustrates one previous approach to decreasing the magnitude of divergence angles of a beam emitted from a laser diode 612. As illustrated in FIGS. 6, as a light beam 632b is emitted from the emitter region 642 of the laser diode 612, it defines a divergence angle 638. Without wishing to be bound by any theory, the diverging nature of the beam 632b can be considered analogous to the well-known divergence which occurs when a wave passes (partially) through an opening or slot in a barrier. A number of factors influence the magnitude of the divergence angle 638, including the wavelength of light, the size 136 of the opening or slot and the difference (if any) in the index of refraction between the material in the laser diode wave guide 644 and the material into which the light is emitted. In the configuration of FIG. 6, the beam 632b is initially emitted into air which has an index of refraction approximately equal to 1.0 while the index of refraction of the material in the wave guide 644 is substantially higher such as in the range of about 2.0 to 4.0. In the approach illustrated in FIG. 6, the beam divergence angle is reduced somewhat by positioning a beam shaping lens 652 in the path of the emitted beam 632b. The lens 652 is mounted by a mounting block or structure 653, so that the lens 652 is spaced a distance 655 from the emitting region 642 of the laser diode 612. The beam shaping lens 652 can be formed with a number of materials including various glasses, quartz, plastics and the like. In previous typical approaches, the lens 652 is formed of a material having a index of refractions substantially greater than that of air such as at least about 2.0. A number of shapes and configurations of the beam shaping lens 652 can be used. In the illustrated configuration, the lens 652 has both a non-planar entrance surface 654a and a non-planar exit surface 654b. In one configuration, both the entrance and exit surfaces 654a,b are hemispherical surfaces. As illustrated in FIG. 6, as the beam 632 passes from the relatively low-index medium of air into the higher-index medium of the lens 652, the beam is bent through an angle 656a,b which effectively reduces the divergence angle. The beam is bent once again 658a, 685b upon exiting the lens 652 to further reduce the divergence angle, providing a divergence angle 660 of the shaped beam 662 which is less than the divergence angle 638 of the beam as it was initially emitted from the laser diode 612.

Although the FIG. 6 illustrates beams or rays in a vertical plane, similar bending of rays and occurrence of interfaces and the like will be found in other planes which intersect the beam.

As seen in FIG. 6, as the beam traverses a path from the interior of the laser diode 612 to a point beyond the beam shaping lens 652, it encounters a number of interfaces (i.e., abrupt changes in the medium of propagation). As the beam exits the laser diode 612, it passes an interface between the wave guide medium 644 and air. When the beam reaches the beam-shaping optics, it passes through another interface between air and the lens material. As the beam exits the beam-shaping optic 652 it passes through a third interface between the lens material and air. Thus, the configuration of FIG. 6 provides at least three interfaces for the beam on its path from the laser diode to a point beyond the beam-shaping lens. Moreover, each of these three interfaces involves a change in index of refraction which is relatively large (such as greater than about 0.25, typically greater than about 0.5 and often greater than about 1).

At each interface, there is a substantial potential for undesired reflections, refractions, diffractions and the like to occur. For example, when the beam 632b reaches the entrance surface 654 of the lens 652, a portion of the light may be reflected, causing a undesirable loss of energy and potentially creating stray light paths that may interfere with the ultimate function of the apparatus. Moreover, the likelihood and/or magnitude of undesired reflections, refractions, diffractions and the like is generally increased when there is a larger difference in the index of refraction on the opposite sides of the interface.

FIG. 7 shows a prior approach which is similar, in some respects, to the approach of FIG. 6. In FIG. 7, however, the entrance surface 754a of the beam-shaping lens 752 is substantially planar. It is believed that, in general, because of the planar nature of the entrance surface 754, the resultant divergence angle 760 of the shaped beam, while it will be smaller than the initial divergence angle 738, will not be as small as the divergence angle 660 obtained in the configuration of FIG. 6 (other things being equal).

A second difference in the configuration depicted in FIG. 7 is that the lens 752 includes mounting or positioning members 772a,b which are sized and shaped to achieve a desired spacing 774 between the facet 716 of the laser diode 712 and the beam shaping lens 752. Although members 772a,b are illustrated with a pointed profile, it is believed that previous approaches have included configurations with rounded-profile members. Although the approach illustrated in FIG. 7 shows member 772a,b contacting the front (facet) plane of the laser diode 712 and mount 714, it is believed that previous approaches have also provided for contact with other surfaces such an upper surface 776 of the laser diode 712. In the embodiment of FIG. 7, just as in the embodiment of FIG. 6, the light beam encounters at least three interfaces along the path from the interior of the laser diode 712 to a point beyond the beam shaping lens 752. Specifically, these include the interface between the laser diode wave guide 744 and the air (in the region 774 spacing the lens from the diode), the interface when the beam enters the entrance surface 754 of the lens 752 and the interface when the beam exits the lens 752 into the atmosphere. Furthermore, just as with the embodiment of FIG. 6, each of the three interfaces involves a relatively large difference in index of refraction. By tracing the edges of the beam backwards, it is possible to define apparent or virtual points of origin 622a, 722a which are spaced distances 624, 724 from the front surface of the laser diodes at 612, 712.

FIG. 5 illustrates a system, method and apparatus according to an embodiment of the present invention. In the embodiment of FIG. 5, a beam-shaping lens 552 includes a substantially planar surface 554a positioned to contact the (planar) surface 584 of the laser diode 512, at least in the region near the emitter region 542 of the laser diode 512. As seen in FIG. 5, when the laser beam is emitted from the laser diode 512 it passes directly (i.e., without first passing through another medium such as air) into the medium of the beam-shaping lens 552. This configuration has a number of characteristics which are believed useful, at least for certain purposes or in certain contexts. First, in the configuration of FIG. 5, the light beam, as it passes from the interior of the laser diode 512 to a point beyond the beam-shaping lens 552, encounters only two interfaces (rather than three, as in the configurations of FIGS. 6 and 7). Namely, these are the interface between the medium of the wave guide 544 and the medium of the lens 552, and a second interface between the medium of the lens 552 and the air or atmosphere beyond the lens. By reducing the number of interfaces, it is believed that the number, likelihood and/or magnitude of undesired interface reflections, refractions or diffractions is reduced, thus reducing the amount of energy lost and/or stray light.

Additionally, the initial beam divergence angle 538 is smaller than corresponding initial beam divergence angles 638, 738 for the configurations of FIGS. 6 and 7 because the index of refraction of the lens medium 552 is greater than that of air. The lens 552 can be made of a number of materials including, for example, glass, (typically with an index of refraction of about 1.5 or more) quartz (typically with an index of refraction of about 1.45) or gallium phosphide (typically with an index of refraction of about 3 or greater). The embodiment illustrated in FIG. 5 shows a lens 552 with a substantially hemispherical shape, although other lens shapes can also be used including anamorphic shapes, e.g., as described below. The diameter or other size of the lens 586 is at least large enough to substantially completely receive the fully extent of the beam as it emerges from the emitter 542 and large enough to provide the desired beam shaping or bending surfaces, typically involving a diameter 586 of at least a few micrometers or more. Furthermore, in at least some embodiments, the lens 552 is provided with a size to facilitate or accommodate lens fabrication, handling and/or connection to the laser diode (including as described in the examples below).

Another feature of the embodiment of FIG. 5 relates to the fact that, of the two interfaces, at least one of them can be configured such that there is a relatively small difference in the index refraction between the media on either side of the interface. Specifically, in at least some embodiments, the lens 552 is formed of a material having an index of refraction which is relatively close to the index of refraction of the wave guide material 544 (such as differing by less than about 0.5, preferably less than about 0.25 even more preferably less than about 0.1). For example, in at least some embodiments the index of refraction of the wave guide material 744 is about 3.5 and the index of refraction of the lens material 552 is about 3.4.

As illustrated in FIG. 5, the configuration in which a surface of lens 552 is in planar or face-to-face contact with the plane or facet of the laser diode emitter 542 (at least at or adjacent the location of the emitter 542) provides an angle of divergence (illustrated, in FIG. 5, in the vertical plane) 560 which is less than that achieved in the configurations of FIG. 6 or 7, 660, 760 respectively.

As noted above, the dielectric coating 518 is configured to provide a desired amount of reflectance of the light back into the laser cavity or wave guide. Since the reflectance properties desired for a stacked plate dielectric coating 518 depend, in part, on the index of refraction of materials on either side of the coating, the materials and/or configuration of the dielectric coating 518 in the embodiment depicted in FIG. 5 is adjusted or modified (compared to the materials or configurations used in previous approaches, such as that depicted in FIGS. 6 and 7), using techniques that will be understood by those of skill in the art, at least after understanding the present invention, to provide the desired amount of reflectance in view of the fact that, in the operative region, the material exterior to the coating 518 is the material of the lens 552 rather than air (as was the case in the configurations of FIGS. 6 and 7).

Several techniques can be used in order to firmly and secure attach the lens in the desired planar or face-to-face contact configuration (i.e., so as to avoid the beam passing through an air gap or other low-index-material region, prior to reaching the beam shaping lens). In one embodiment, an adhesive is applied to all or part of the planar surface of the lens 552 and/or a corresponding region of the laser diode/mount surface. In one embodiment, such adhesive layer, while having an index of refraction greater than that of air, has an index of refraction which is different from that of the wave guide 544 and/or lens 552 thus providing a configuration in which the beam experiences three interfaces (wave guide to adhesive, adhesive to lens and lens to air), although at least some of the benefits of the present invention are achieved because of the lack of an air gap and the relatively high index of the adhesive, compared to the index of refraction of air.

In another embodiment, the adhesive and/or lens are selected such that the index refraction of the adhesive is substantially equal to that of the lens (and/or the wave guide 744, 544), thus, effectively eliminating an interface (since as noted above, an interface occurs at the juncture of two materials with different indices of refraction), providing a configuration with only two interfaces (as illustrated and described in connection with FIG. 5). For example, in one embodiment, the adhesive and the lens each have an index of refraction of about 1.55. In another embodiment, a connecting layer, such as a layer of adhesive, solder or the like, is positioned spaced from the area adjacent the emitter 542. For example, in the embodiment illustrated in FIG. 8, a section 892 of an annular area partially surrounding and spaced from the emitter 542 is provided with a connecting layer such as a layer of adhesive, solder (e.g., eutectic solder), positioned on the laser diode facet (or, more properly, the dielectric coating 518 positioned thereon) and/or on a corresponding area 894 of the lens 552. The lens is then positioned 596 in the desired location (such as with the center point of the hemispherical lens 552 positioned along a line which passes through the center of the emitter 542). In at least some embodiments, an additional step of curing (such as ultraviolet curing of an adhesive) or heating (such as laser or inductive heating of solder) is performed to achieve the desired bond or connection.

In one embodiment, the thickness (in a direction perpendicular to the lens planar surface 554a) of the solder adhesive or other bonding layer is, after heating or curing, substantially negligible (such as being no more than a few atoms thick) such that the adhesive or solder does not form a “standoff” (and thus avoids creating an air gap between the emitter 542 and the lens 552.

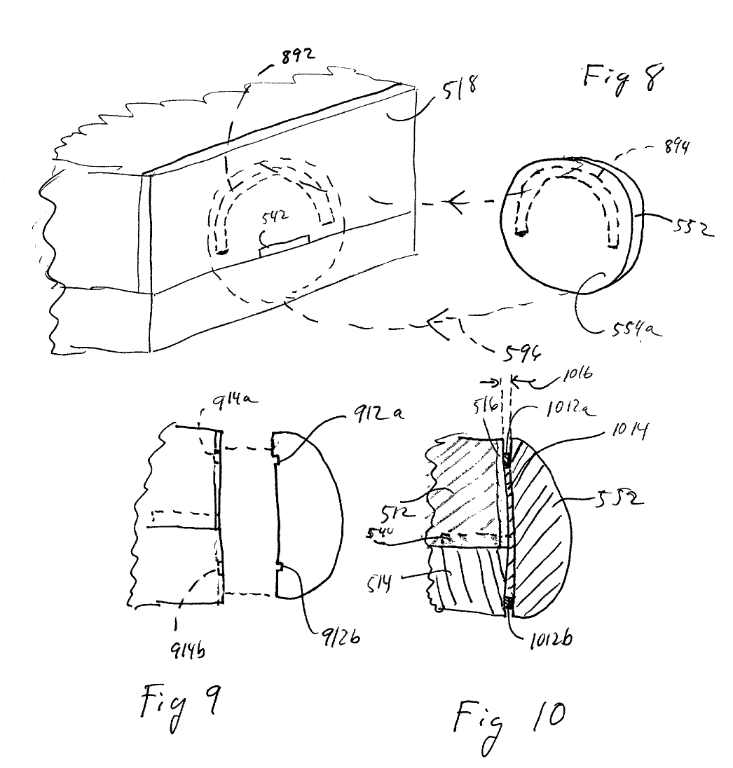

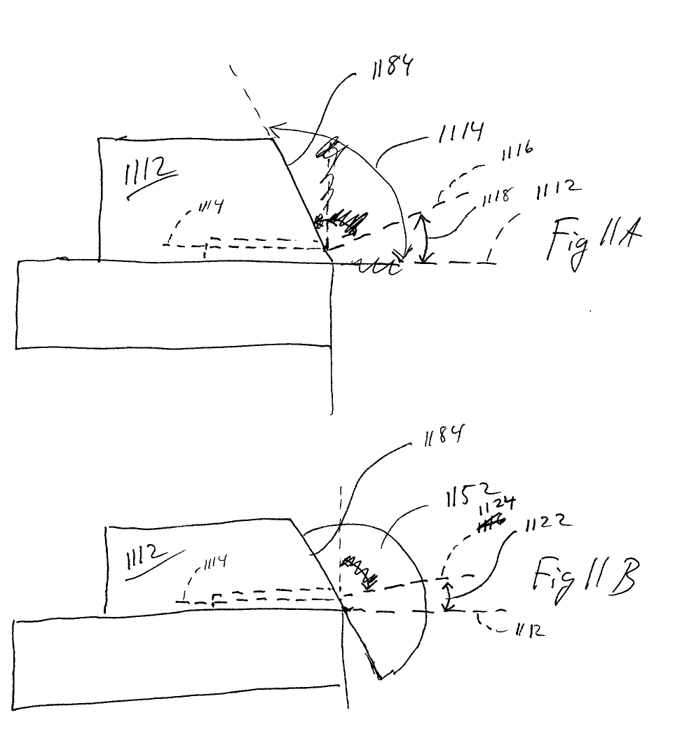

In another embodiment, grooves, pockets or the like are formed in the lens 912a,b and/or laser diode/mount 914a,b (FIG. 9) to receive and accommodate the adhesive solder or other bonding material so the desired face-to-face or plane-to-plane contact of the lens with the emitter 542 is achieved.

In another embodiment, as illustrated in FIG. 10, a ring or other region of solder adhesive or the like 1012a, 1012b is used to bond or couple the lens 552 to the laser diode 512 and/or mount 514. The region 1014 between lens 552 and the laser diode 512, and surrounded by the ring (or other shape) of solder or adhesive 1012a, 1012b is filled with a relatively high-index material, preferably a material with an index substantially equal to the index of the lens 552 and/or wave guide 544. In this way, even though the lens 552 is spaced a small distance 1016 from the facet of the laser diode 512, there is no air gap since such space is filled with a high-index material 1014. The high-index material 1014 can be a solid material or a liquid material including a high-index oil.

As depicted in FIG. 11A, in many instances it is found that the (typically cleaved) emitting facet 1184 of the laser diode 1112 is not at an angle which is precisely 90° with respect to a line 1112 parallel to the wave guide longitudinal axis 1114. Instead, the facet 1184 defines an angle 1114 which is different from 90°. Although the configuration of FIG. 11A and 11B depicts a non-orthogonal facet where the angle is somewhat exaggerated, for purposes of clarity, even for relatively small departures from 90°, one effect is that the axis of the beam (or “Z” axis 1116) is moved to an angle 1118 different from the wave guide axis 1114. By providing a configuration such as that illustrated in FIG. 11B, in which the beam, as it leaves the laser diode 1112, is emitted directly into a lens or other high-index medium 1152, the magnitude of the angular difference 1122 of the beam z axis 1124, compared to a line 1112 parallel to the wave guide axis 1114 is less than in the configuration of FIG. 11A, where the beam is (at least initially) emitted into an air medium. Accordingly, an additional advantageous aspect of the present invention is to decrease the angular error or pointing error which can arise from a given amount of non-perpendicularity of the emitting facet 1184 of the laser diode 1112 or other asymmetry such as effective index differences from one side of the waveguide to the other.

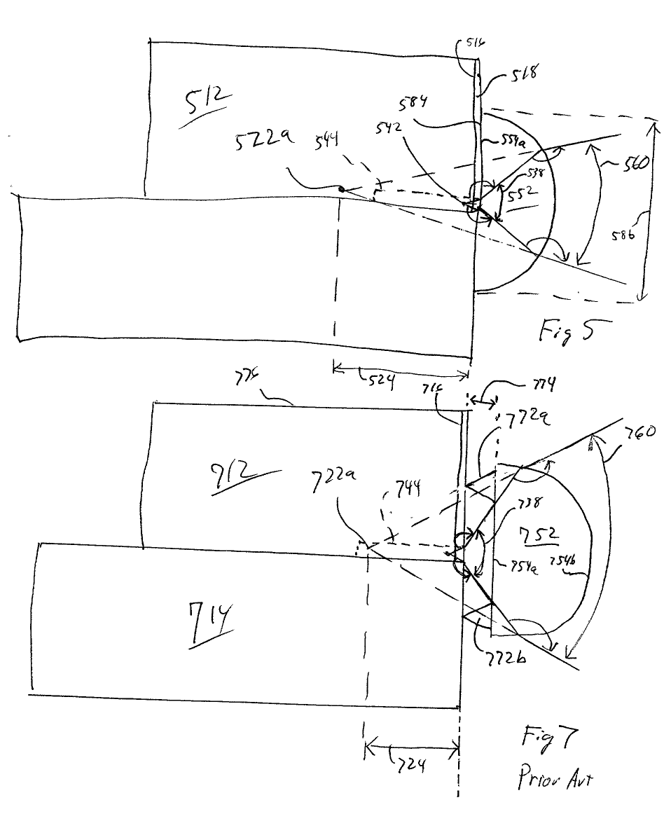

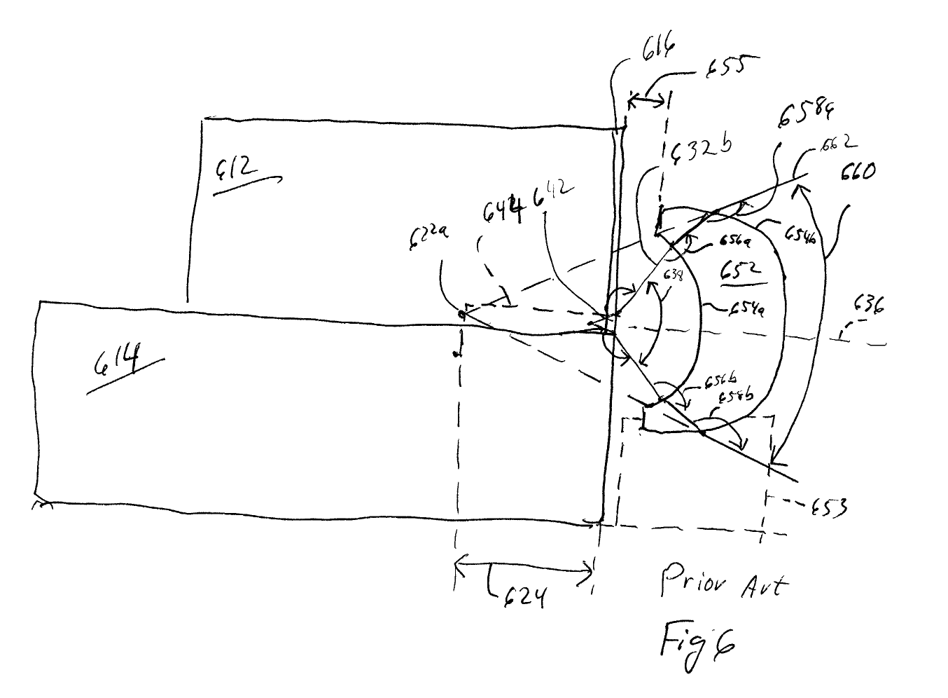

Although FIG. 5 generally illustrates use of a hemispheric lens 552, the present invention can be used in connection with many different lens shapes or configurations. A comparison of FIGS. 3A and 3B with FIGS. 4A and 4B provides an illustrative (but not exhaustive) example in this regard. In the example of FIGS. 3A and 3B, a hemispheric lens 352 is positioned and configured, according to an embodiment of the present invention, to provide a reduction in the divergence angle 334 in a horizontal plane compared to the divergence angle 234 without a lens where the divergence angle 334 is reduced by a factor of 1/M (compared to the divergence angle 234 in the absence of the lens 352.) Similarly, the same reduction by a factor of 1/M is achieved by lens 352 in the divergence angle 338 in the vertical plane (compared to the divergence angle 238 in the absence of the lens 352). FIGS. 4A and 4B illustrate an effect achieved when a hemi-cylindrical lens 452 is used, rather than a hemispherical lens. In the hemi-cylindrical lens, the exit surface of the lens has a semicylindrical profile in the vertical cross-section FIG. 4B but has a substantially planar profile in the horizontal cross-section of FIG. 4A. As a result, although the divergence angle of beam in the vertical plane 438 is reduced by a factor of 1/M, there is substantially no change made to divergence angle of the beam in the horizontal plane 434. By providing the greatest amount of divergence reduction in the plane which would (otherwise) have the greatest amount of divergence, the amount of non-circularity (ellipticity) of the beam can be reduced or eliminated. For example, if the ellipticity of the beam, in the absence of a lens, is defines a vertical to horizontal cross-sectional extent with a ratio of M, the hemi-cylindrical lens 452 will act to substantially circularize the beam. As will be understood by those of skill in the art, other, generally anamorphic, lens shapes or configurations can be provided which will provide various types of beam shaping including various degrees of divergence reduction and/or ellipticity reduction.

In light of the above discussion, a number of advantages of the present invention can be seen. The present invention includes a recognition that, in at least certain contexts or for certain purposes, the possibly advantageous aspects associated with having a second curved surface to the lens 654a (FIG. 6), having mountings 653 or members 772a,b for positioning a lens spaced 774, 655 from the laser diode or other features which provide or create an air gap (or similar low-index space) between the emitter 642 and the lens 652 can be outweighed by the disadvantages associated with such an air gap, including providing an undesirably large number of interfaces and/or an undesirably large difference in index of refraction across such interfaces. Accordingly, embodiments of the present invention can achieve elimination of the air gap, can achieve reduction of the number of interfaces experienced by the beam as it travels from the interior of the laser diode to a position beyond the beam shaping lens and/or can achieve a reduction in the index difference across such intervals. The present invention can achieve a reduction in the difficulty or cost of manufacture such as by avoiding independent alignment or mounting apparatus or procedures (e.g., compared to the configuration of FIG. 6). The present invention can achieve improved sturdiness or durability of the connection between the laser diode and the lens by providing the potential for face-to-face or planar coupling or adhesion, including providing adhesion or soldering which extends over a (two dimensional) region of the planar laser diode face and/or planar lens region, as compared with, e.g., the configuration of FIG. 7 which can provide only (one dimensional) lines or points of contact or adhesion toward the laser diode emitting face. By reducing or eliminating interfaces, air gaps, and/or index differences at such interfaces, the present invention can reduce the amount of light or light energy which is lost, can reduce stray light, can improve power budgets or energy budgets or thermal budgets and the like. The present invention can reduce the adverse affects, such as angular and/or pointing errors, associated with laser diode cleaved faces which are not perpendicular to the wave guide axis, or those associated with waveguides having asymmetric effective indices across the waveguide profile.

A number of variations and modifications of the present invention can be used. It is possible to use some aspects of the invention without using other aspects. For example, it is possible to configure or attach a lens with respect to a laser diode so as to reduce the number of interfaces and/or the index-difference across such interfaces, without necessarily employing such lens for the purpose of fully or partially circularizing a beam. The present invention can be used in a number of devices or apparatuses which employ write including data readers and writers such as those described in U.S. patent application Ser. Nos. 09/315,389, 60/140,637 and 09/457,104, supra. CD or DVD players or recorders, bar code scanners and the like. Configurations of the present invention can be used in combination with other optical components such as other lenses, gratings, holograms, mirrors, beam splitters, and the like. Although the present invention has been described in connection with laser diodes, other laser light sources can also be used in the context of the present invention. Although embodiments have been described in which the interface between the emitter and the beam shaper lens has a planar shape, it is also at least theoretically possible to provide a laser emitter which has a non-planar exit or emitting surface and to provide a lens, oil or other high-index member or component with a complementary shape, e.g., so as to eliminate an air gap or other region with low index material between the laser emitter and the beam shaper optic.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g. for improving performance, achieving ease and/or reducing cost of implementation. The present invention includes items which are novel, and terminology adapted from previous and/or analogous technologies, for convenience in describing novel items or processes, do not necessarily retain all aspects of conventional usage of such terminology.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g. as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. Apparatus providing a shaped laser beam comprising:
a laser light source having an emitter surface;
a beamshaping optic having a beam entrance surface, located in a fixed position with respect to said laser light source such that said beam entrance surface is substantially adjacent said emitter surface;
wherein, when said laser beam is emitted from said laser light source in the absence of said laser beam passing through a medium with an index of refraction equal to about 1, prior to reaching said entrance surface.

2. Apparatus, as claimed in claim 1, wherein said laser light source is a laser diode.

3. Apparatus, as claimed in claim 1, wherein said beamshaping optic is a lens.

4. Apparatus, as claimed in claim 1, wherein said entrance surface and said emitter surface are substantially planar.

5. Apparatus, as claimed in claim 4, wherein said entrance surface and said emitter surface are substantially in plane-to-plane contact.

6. Apparatus, as claimed in claim 1, wherein said position of said beamshaping optic is provided such that there is substantially no air gap between said emitter surface and said entrance surface.

7. Apparatus, as claimed in claim 1, wherein said entrance surface is at least partially spaced from said emitter surface, defining a first region therebetween and wherein said first region is substantially filled with a material having an index of refraction greater than about 1.

8. Apparatus, as claimed in claim 1, wherein said entrance surface is at least partially spaced from said emitter surface, defining a first region therebetween and wherein said first region is substantially filled with a material having an index of refraction greater than about 1.5.

9. Apparatus, as claimed in claim 1, wherein said entrance surface is at least partially spaced from said emitter surface, defining a first region therebetween and wherein said first region is substantially filled with a material having an index of refraction greater than about 2.

10. Apparatus, as claimed in claim 7, wherein said material which substantially fills said first region has an index of refraction substantially equal to the index of refraction of said beamshaping optic.

11. Apparatus, as claimed in claim 7, wherein said material which substantially fills said first region has an index of refraction substantially equal to the index of refraction of at least a portion of said laser light source.

12. Apparatus, as claimed in claim 7, wherein said material which substantially fills said first region includes an adhesive.

13. Apparatus, as claimed in claim 7, wherein said material which substantially fills said first region includes a eutectic solder.

14. Apparatus, as claimed in claim 1, further comprising at least a first recess formed adjacent said entrance surface configured to receive at least a first bonding material.

15. Apparatus, as claimed in claim 14, wherein said first bonding material is selected from among an adhesive or a solder.

16. Apparatus, as claimed in claim 1, further comprising at least a first recess formed adjacent said emitter surface configured to receive at least a first bonding material.

17. Apparatus, as claimed in claim 16, wherein said first bonding material is selected from among an adhesive or a solder.

18. Apparatus, as claimed in claim 1, wherein said beamshaping optic is configured to at least partially reduce a divergence angle of said laser beam.

19. Apparatus, as claimed in claim 1, wherein said beamshaping optic is configured to at least partially reduce ellipticity of said laser beam.

20. Apparatus, as claimed in claim 1 wherein said beamshaping optic comprises a hemispherical lens.

21. Apparatus, as claimed in claim 1, wherein said beamshaping optic comprises a hemicylindrical lens.

22. Apparatus providing a shaped laser beam comprising:
a laser light emitting means having an emitter surface;
a beamshaping means having a beam entrance surface, located in a fixed position with respect to said laser light emitting means such that said beam entrance surface is substantially adjacent said emitter surface;
wherein, when said laser beam is emitted from said laser light emitting means in the absence of said laser beam passing through a medium with an index of refraction equal to about 1, prior to reaching said entrance surface.

23. Apparatus, as claimed in claim 22, wherein said laser light emitting means is a laser diode.

24. Apparatus, as claimed in claim 22, wherein said beamshaping means is a lens.

25. Apparatus, as claimed in claim 22, wherein said entrance surface and said emitter surface are substantially planar.

26. Apparatus, as claimed in claim 25, wherein said entrance surface and said emitter surface are substantially in plane-to-plane contact.

27. Apparatus, as claimed in claim 22, wherein said position of said beamshaping means is provided such that there is substantially no air gap between said emitter surface and said entrance surface.

28. Apparatus, as claimed in claim 22, wherein said entrance surface is at least partially spaced from said emitter surface, defining a first region therebetween and wherein said first region is substantially filled with a material having an index of refraction greater than about 1.

29. Apparatus, as claimed in claim 22, wherein said entrance surface is at least partially spaced from said emitter surface, defining a first region therebetween and wherein said first region is substantially filled with a material having an index of refraction greater than about 1.5.

30. Apparatus, as claimed in claim 22, wherein said entrance surface is at least partially spaced from said emitter surface, defining a first region therebetween and wherein said first region is substantially filled with a material having an index of refraction greater than about 2.

31. Apparatus, as claimed in claim 28, wherein said beamshaping means has an index of refraction and wherein said material which substantially fills said first region has an index of refraction substantially equal to the index of refraction of said beamshaping means.

32. Apparatus, as claimed in claim 28, wherein at least a portion of said laser light emitting means has an index of refraction and wherein said material which substantially fills said first region has an index of refraction substantially equal to the index of refraction of said at least a portion of said laser light emitting means.

33. Apparatus, as claimed in claim 28, wherein said material which substantially fills said first region includes an adhesive.

34. Apparatus, as claimed in claim 28, wherein said material which substantially fills said first region includes a solder.

35. Apparatus, as claimed in claim 22, further comprising at least a first receiving means formed adjacent said entrance surface configured to receive at least a first bonding means.

36. Apparatus, as claimed in claim 35, wherein said first bonding means is selected from among an adhesive or a solder.

37. Apparatus, as claimed in claim 22, further comprising at least a first receiving means formed adjacent said emitter surface configured to receive at least a first bonding means.

38. Apparatus, as claimed in claim 37, wherein said first bonding means is selected from among an adhesive or a solder.

39. Apparatus, as claimed in claim 22, wherein said beamshaping means is configured to at least partially reduce a divergence angle of said laser beam.

40. Apparatus, as claimed in claim 22, wherein said beamshaping means is configured to at least partially reduce ellipticity of said laser beam.

41. Apparatus, as claimed in claim 22, wherein said beamshaping means comprises a hemispherical lens.

42. Apparatus, as claimed in claim 22, wherein said beamshaping means comprises a hemicylindrical lens.

43. A method providing a shaped laser beam comprising:
providing a laser light source having an emitter surface;
locating a beamshaping optic having abeam entrance surface, in a fixed position with respect to said laser light source such that said beam entrance surface is substantially adjacent said emitter surface;
emitting said laser beam from said laser light source in the absence of said laser beam passing through a medium with an index of refraction equal to about 1, prior to reaching said entrance surface.

44. A method as claimed in claim 43, wherein said step of providing said laser light source comprises providing a laser diode.

45. A method as claimed in claim 43, wherein said step of locating said beamshaping optic comprises locating a lens.

46. A method as claimed in claim 43, wherein said entrance surface and said emitter surface are substantially planar.

47. A method as claimed in claim 46, wherein said step of locating said beamshaping optic comprises contacting said entrance surface with said emitter surface.

48. A method as claimed in claim 43, wherein said step of locating said beamshaping optic comprises locating said beamshaping optic such that there is substantially no air gap between said emitter surface and said entrance surface.

49. A method as claimed in claim 43, wherein said step of locating said beamshaping optic comprises at least partially spacing said entrance surface from said emitter surface, defining a first region therebetween and wherein said first region is substantially filled with a material having an index of refraction greater than about 1.

50. A method as claimed in claim 43, wherein said step of locating said beamshaping optic comprises at least partially spacing said entrance surface from said emitter surface, defining a first region therebetween and wherein said first region is substantially filled with a material having an index of refraction greater than about 1.5.

51. A method as claimed in claim 43, wherein said step of locating said beamshaping optic comprises at least partially spacing said entrance surface from said emitter surface, defining a first region therebetween and wherein said first region is substantially filled with a material having an index of refraction greater than about 2.

52. A method as claimed in claim 49, wherein said beamshaping optic has an index of refraction and wherein said material which sub substantially fills said first region has an index of refraction substantially equal to the index of refraction of said beamshaping optic.

53. A method as claimed in claim 49, wherein at least a portion of said laser light source has an index of refraction and wherein said material which substantially fills said first region has an index of refraction substantially equal to the index of refraction of said at least a portion of said laser light source.

54. A method as claimed in claim 49, wherein said material which substantially fills said first region includes an adhesive.

55. A method as claimed in claim 49, wherein said material which substantially fills said first region includes a solder.

56. A method as claimed in claim 43, further comprising forming at least a first recess adjacent said entrance surface configured to receive at least a first bonding material.

57. A method as claimed in claim 56, wherein said first bonding material is selected from among an adhesive or a solder.

58. A method as claimed in claim 43, further comprising forming at least a first recess adjacent said emitter surface configured to receive at least a first bonding material.

59. A method as claimed in claim 58, wherein said first bonding material is selected from among an adhesive or a solder.

60. A method as claimed in claim 43, wherein said beamshaping optic is configured to at least partially reduce a divergence angle of said laser beam.

61. A method as claimed in claim 43, wherein said beamshaping optic is configured to at least partially reduce ellipticity of said laser beam.

62. A method as claimed in claim 43, wherein said beamshaping optic comprises a hemispherical lens.

63. A method as claimed in claim 43, wherein said beamshaping optic comprises a hemicylindrical lens.
